(19) United States
(12) Patent Application Publication
(10) Pub. No.: US 2011/0241871 A1
(43) Pub. Date: Oct. 6, 2011

(54) Sensor Alert

(76) Inventor: Charles Durio, Blue Springs, MO (US)

(21) Appl. No.: 13/077,555

(22) Filed: Mar. 31, 2011

Related U.S. Application Data
(60) Provisional application No. 61/321,275, filed on Apr. 6, 2010.

(51) Int. Cl. G08B 23/00

(52) U.S. Cl. 340/539.11

(57) ABSTRACT

A stand-alone alert device that monitors electrical inputs from a third party sensor and alerts a user of a condition change via a cell phone or embedded transmitter. Typical inputs are one or more switches or environmental sensors of various types. User accessible settings allow configuring the device for different sensor output types. The device may also be set to make daily calls at a specific time to indicate device integrity. Power for the control circuit and the cell phone or embedded transmitter may be supplied via a battery pack when connection to public power is not desired or possible. By employing battery power, a flexible sensor interface and cellular telephony, the device enables simple and low cost monitoring in remote, mobile, temporary, clandestine or otherwise restrictive circumstances.

### CROSS REFERENCE TO RELATED APPLICATION

This application claims the benefit of U.S. Provisional Application No. 61/321,275 filed on Apr. 6, 2010, entitled “Sensor Alert”

### BACKGROUND OF THE INVENTION

1. Field of the Invention

The present invention relates to telephone alarm systems and electronic sensor devices. More specifically, the present invention relates to stand-alone alarm systems capable of sending phone calls from a mobile phone in response to a third party alarm trigger.

2. Description of the Prior Art

Security and emergency alarm systems are well known in the art and are extensively used in commercial and residential environments. These systems generally operate on available NC power to monitor a given array of sensors that trigger an alarm if provided the proper stimulus. Alarms commonly include motion sensing, the presence of fire or smoke, entry breach, glass shatter or other similar emergency or security situation. These devices generally utilize a mechanical device to modulate an electrical signal in the form of a continuity or voltage change, which is monitored by a larger system that sends out an alarm when the specific sensor is triggered. Many variations are common throughout the art.

Those systems that utilize a phone to send an alert are also known in the art. Home and business security systems typically rely on a landline telephone service for communicating an alarm to a host company, which is paid to monitor the residence or commercial property. Some of these utilize a cellular phone capability or back-up system to communicate with the monitoring service, while still others rely on a cellular phone as the primary mode to transmit an alert signal directly to a user.

U.S. Published Patent Application, Publication No. 2003/0104800 to Zak, describes a telephone based alarm system that makes a call to a user though a preset phone number based on an activated alarm. The system can run from any number of phones, including landlines or wireless devices. A battery backup is provided for use with a wireless device.

U.S. Published Patent Application, Publication No. 2009/0191839 to Cannon, describes another telephone based alarm system for initiating remedial actions based on observations from another device. The system can make a call to a user and initiate an alarm based on an emergency situation.

U.S. Pat. No. 7,460,655 to Fujisawa describes a picture telephone monitoring system that sends video from one phone to another based on infrared sensors detecting movement in a given area. A plurality of picture phones may be stationed within an area to monitor the environment and transmit a video signal to a second phone carried by a user to view the actions within the area if a signal is tripped showing motion.

Similar to the Fujisawa patent, U.S. Pat. No. 6,956,599 to Lim describes another video monitoring system based on wireless phone capable of capturing video. A plurality of video phones are utilized to establish a low cost monitoring service that is capable of communicating with an outside phone to relay signals.

While the devices are useful means of utilizing a mobile phone or landline phone to monitor a situation and provide feedback to a user, they include several drawbacks that the disclosed invention attempts to resolve. Most phone security systems are custom-built for a location, and do not include the modularity required to be used in different scenarios or locations. These devices are static in nature, and fill a singular role such as home invasion protection and emergency response notification. A system is required wherein the same device can be utilized for a number of different scenarios, provide notification to a user based on feedback from an associated sensor, and one that is inexpensive to establish and maintain.

The instant invention is a unique device and alert method that provides a compact, low cost and modular system that can be utilized in a number of scenarios and locations and in conjunction with a plurality of sensors or similar devices.

### SUMMARY OF THE INVENTION

In view of the foregoing disadvantages inherent in the known types of wireless phone alert systems now present in the prior art, the present invention provides a new wireless phone alert system wherein the same can be utilized for providing convenience when providing an alert signal in the form of a cellular call to a user when a monitoring sensor has been activated.

It is therefore an object of the present invention to provide device that combines a push-button mobile phone or cell phone transmitter, an attached control circuit that controls the phone, and a variety of DC power sources including batteries.

Another object of the present invention is to provide a stand-alone alert system that accepts signals from a third party sensor, in the form of a binary change in continuity or voltage change from a single sensor or from a combination of sensors, and notifies a user with a phone call in the event of any condition change.

Another object of the present invention is to provide an invention that responds to third-party sensor signals according to various programmable settings.

Another object of the present invention is to provide a device that operates in a plurality of situations, in tandem, and with multiple types of monitoring sensors, while operating for extended periods of time using direct current power. The power source may be derived from grid power, a generator or by a battery independent of grid power.

Another object of the present invention is to provide an operational signal associated with the alert device that assures a user that the invention is powered and functioning by making an cellular call at a chosen daily time.

Another object of the present invention is to provide a counter that initiates the phone alert as many times as the associated monitoring sensor is tripped, even if the sensor is re-tripped before a preceding phone alert has been completed, providing a user the ability to track the number of sensor trips occurring in a given situation.

Yet another object of the present invention is to provide an inexpensive, compact and reliable device that can operate independently of grid power and provide a monitoring capability for a user that fills the role of a larger security system, with increased adaptability, simplicity and reduced oversight requirements.

The disclosed invention is useful in many monitoring situations. No telephone land line is used and no AC power is required, which allows the invention to operate in vacant buildings, locations where public power and telephone line connections are vulnerable to tampering, and in remote or undeveloped locations. The size of the device also allows for concealment. Some examples of situations appropriate to monitor are emergency situations such as fire and smoke, trespass in a business or residence, freezing temperatures on a farm or orchard, overpressure in a pipeline or pressure vessel, high or low water level of a lake or pond, traffic on a private road, or a failed drainage pump. Typical recipients of the alert calls may be property owners, security monitoring companies, property managers, ranchers, farmers, construction workers or homeowners.

A single direct current power source provides the power for both the control circuitry and the cell phone or embedded transmitter. The power may be derived from an external AC current converted into DC or from connected batteries. The capacity of the battery may be increased to extend the time between replacements. An internal storage capacitor provides power to prevent loss of settings during short interruptions in supplied power, such as when replacing batteries.

The disclosed invention can receive any input that changes between two states in the form of either open or closed continuity (dry contacts), or in the form of either a disconnected state or a positive voltage (sourcing), or in the form of either a disconnected state or ground (sinking), or in the form of either a positive voltage or ground (sourcing and sinking). Inputs may be from mechanical switches or sensors that change state at pre-set levels of environmental variables such as temperature, moisture, pressure, light, sound, magnetic flux, motion, smoke or carbon monoxide.

The device can be configured by front panel accessible settings to adapt to different sensor types and different monitoring situations. These options may include the averaging period—the time within which the inputs must be active more than fifty percent of the time for an event to be recognized, and the inhibit period—the time after an event is recognized before a subsequent event will be recognized, normally open or normally closed sensor contacts, and whether contacts must return to their normal sensor state before a subsequent event will be recognized. The device can also be set to stay on-line or hang up after an alert call. The device can be set to make daily check-in cellular calls. The current time and the daily check-in call time can be set using the front panel.

Each sensor alert device includes a cell phone or embedded transmitter which is programmed with a phone number to dial in the event of the sensor trigger. Once the device is stationed, power and sensors are connected, and the invention is configured and enabled, any change between two states of the inputs is interpreted by the device, activating an outgoing cellular call to notify a user. The onboard cell phone or embedded transmitter number and time of the call will be available as caller ID information on the recipient's phone. Thus, the call recipient will be alerted to the state change in sensor or sensors at the monitoring site.

Other objects, features and advantages of the present invention will become apparent from the following detailed description taken in conjunction with the accompanying drawings.

### BRIEF DESCRIPTIONS OF THE DRAWINGS

FIG. 1 shows an overview of the sensor alert device, including typical scenarios, third party sensor types, environmental conditions and recipients that may utilize the system.

FIG. 2 shows an exploded perspective view of the sensor alert device.

### DETAILED DESCRIPTION OF THE INVENTION

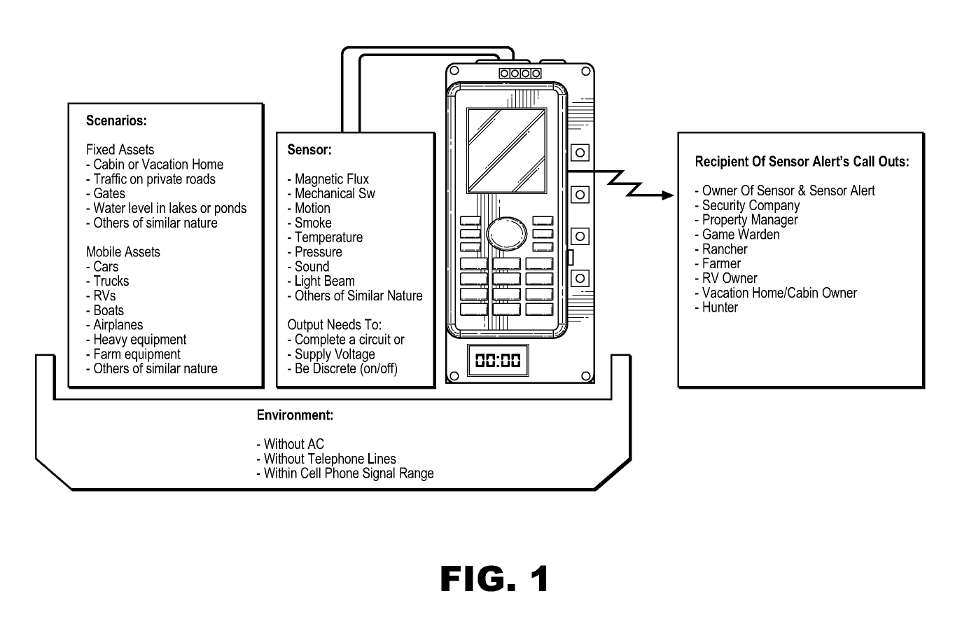

Referring now to FIG. 1, there is shown an overview of the sensor alert device, including its functions, third party sensor types and recipients. The device monitors signals from a third party sensor, which can be chosen from any number of sensors that send a signal to the alert device in response to a change in a given condition. The signal may take the form of a binary change in continuity or voltage change. Sensors may include those devices that react to magnetic flux, the state of a mechanical switch, motion, smoke or carbon monoxide, temperature change, pressure change, sound change, light sensitivity, or any other physical state or outside stimulus that effects a change in the monitoring device that manifests in a signal to the alert device. These are typically electro-mechanical sensors capable of detecting a change in state of a given condition.

The sensor alert device is useful in many scenarios in which larger systems or those requiring grid power are not capable of operating. These scenarios can be broken down into two categories: fixed assets and mobile assets. Fixed assets include those that involve stationary objects such as a residence or other fixed property. Monitoring of fixed assets includes trespass monitoring in a business or residence, monitoring emergency situations such as fire and smoke, monitoring freezing temperatures on a farm or orchard, monitoring pressure in a pipeline or pressure vessel, monitoring a water level of a lake or pond, or any other situation involving a static or quasi-static environment. Mobile assets, by contrast, include those scenarios that involve a dynamic environment. Typical situations include monitoring traffic on a private road, those that include cars, trucks, RVs, boats, airplanes, heavy equipment or farm equipment, monitoring wildlife or other movement along a trail or path, or any other situation in which a monitoring sensor is changing between two electrical states.

Referring again to FIG. 1, the deployed sensor and the scenario being monitored are encompassed by an environment in which the device operates without grid power input, without a physical telephone line and within cell phone signal range. The adaptability and plurality of situations in which the device can be deployed is a crucial component to its utility. An active cell phone signal and power is the only requirement for complete functionality. Power is supplied to a control circuit via a plurality of batteries. The control circuit supplies the appropriate electrical power to the cell phone for sustained operation beyond the range of a commercial cell phone battery. The battery pack may comprise any type or quantity of batteries desired by the user. The embodiment shown in the figures is an array of alkaline flashlight batteries. The chosen battery pack may include alkaline, lithium ion, nickel cadmium, nickel-metal hydride, carbon zinc, or any other appropriate battery that supplies a constant supply of power for a desired period of time. The control circuit is powered during the entire deployment of the device, drawing minimal power for sustained operation. Upon tripping of the sensor, the control circuit initiates the programmed speed dial number, sending an outgoing call to a recipient. No physical connection to a telephone line is required or external power, which allows the device to be operated in remote or undeveloped locations.

Once the device is stationed, lead wires are supplied to the associated monitoring sensor utilized for the given scenario. Once the sensor has been provided a desired physical stimulus, its signal is interpreted by the alert device, activating an outgoing call to notify a user. The cell phone is programmed with a preset outgoing number to dial in the event of the sensor tripping. The user may deploy multiple, redundant or cooperating sensor alert devices in a given situation. Each sensor includes a separate cell phone device with different outgoing phone numbers. The outgoing phone number displays as digits for the user to interpret as a sensor trips at a given location or time. In this way, the user can interpret the situation without physically being present at the event, and take appropriate action. Typical recipients of the alert system may include the owner of the device, a monitoring security company, a property manager, residence owner or other similar recipient with a vested interest in the monitored situation or owner of the device.

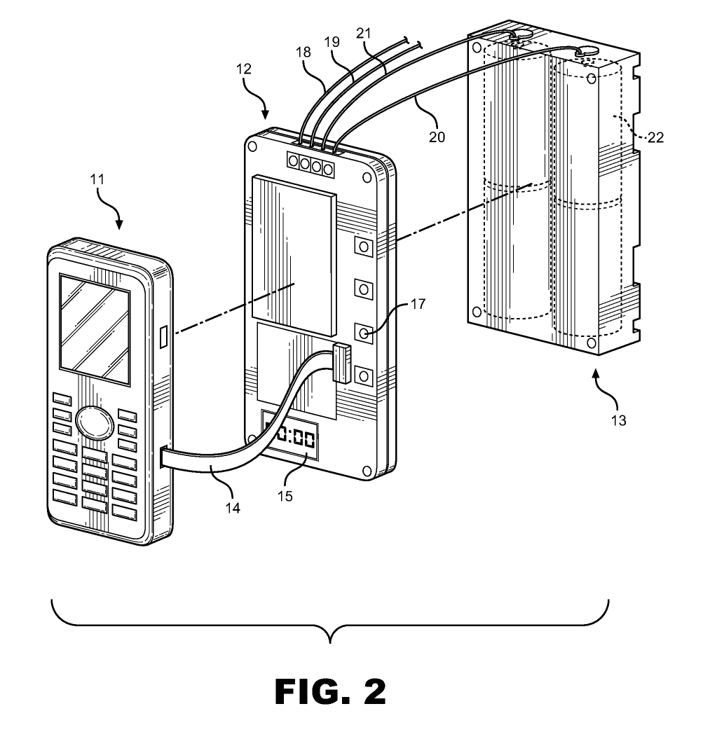

Referring now to FIG. 2, there is shown an exploded perspective view of the disclosed invention, including a cellular phone 11, an enclosure containing a control circuit 12 and a battery pack 13. The cell phone 11 is a standard, push-button phone that can make an outgoing call using a preset phone number. The type of phone may include any type compliant to the local cellular service network, such as CDMA, GSM, or the like. The control circuit 12 sends signals and power to the attached cellular phone 11 through a cable 14, allowing outgoing call control and power transfer. The phone 11 may be physically mated using an attachment means to the control circuit 12 to organize and colocate the assembly. The attachment means may include hook and loop fasteners, a latch and hook mechanism, a fabricated slot on the outside surface of the enclosure for the cell phone to attach or nest, or any other suitable means known to one skilled in the art.

A digital display 15 is positioned at the base of the enclosure 12 for viewing the device settings and operating parameters. A plurality of control buttons 17 line the side of the control circuit enclosure 12 for the user to update settings and walk through a series of operating parameters that are controllable by the control circuit. These may include setting the time of day on the device, setting the “check-in” call time, the averaging period and the inhibit period. The phone 11 can be controlled to reset after subsequent alert signals, stay on-line or hang up after an alert call, or to make daily ‘check-in’ phone calls. The ‘check-in’ calls are a recurring outgoing signal to ensure the user that the device is still operational. One of the buttons may be used as an external disable switch, or a flip switch may be connected to the control circuit enclosure as a remote ON or OFF switch.

The averaging period is a programmed time setting to smooth out noise from the third-party sensor output. Some sensors generate noise that can trigger false alarms. Setting a period of time to average signals from a third-party sensor ensures the signal is not an anomaly or random spike that does not require an alert. The averaging period sets a time that the alert device will monitor an incoming signal, authenticate the signal is showing “on” for that period, and then initiate an outgoing call. In this way, only genuine signals are acted upon and false alarms are reduced.

The inhibit period is a time setting to ignore third-party sensor outputs after an alert has been initiated and a recipient is notified. The time period controls how long the device will ignore the sensor signals before resuming making an alert call upon a sensor trip. Situations where this may be useful include those that change condition slowly, which would continually trigger the sensor and send repeated calls to the user. Monitoring the surface level of a large body of water is one such example, wherein the water level may stay too low or too high for extended periods of time. The inhibit period sets a time period to ignore repeated signals from a third-party sensor, reducing redundant alerts.

Inputs along the control circuit 12 include positive and negative power terminals 20,21 from the battery pack 13 for incoming power, as well as lead wires 18,19 for connection with a third party sensor. The lead wires 18, 19 can be any length sufficient to connect the monitoring device to the control circuit 12 in the desired scenario. The sensor alert device is not restricted by the distance from the sensor, as long as an adequate signal can be transferred along the lead wires to be interpreted by the control circuit 12 logic. The battery pack may be any size to accommodate the desired batteries 22, depending on duration of use and power demands.

A routine within the control circuit program provides a means of making a cellular call as many times as the associated monitoring sensor is tripped even if the sensor is re-tripped before a preceding cellular call has been completed, thus providing a user the ability to track the number of sensor trips occurring in succession.

In an alternate embodiment of the disclosed invention, the push button cellular phone is replaced with a cellular transmitter.

In total, the disclosed invention provides users the ability to monitor third-party sensors in environments without available AC power and without available telephone lines. The device can be used for a wide variety of monitoring situations, alerting consumers in the event of break-in, smoke detector activation in remote sheds or barns, and other urgent or emergency situations. It uses an independent cell phone unit that works within signal ranges using very basic cell phone functions, providing users with a simple, low-cost sensor alert system.

The device is deployable in a number of situations without requiring a sophisticated setup or upfront costs associated with commercial surveillance or security systems. The device is designed to monitor specific areas and send alerts to recipients via cellular phone calls. Many situations are relevant to the disclosed invention, particularly security, third-party monitoring and emergency notification. Monitoring and alert calls are operable from remote locations and environments unsuitable for standard security systems. The user is able to monitor locations from distance locations, providing piece of mind or alerting the user of a situation upon occurrence.

A crucial component of the system's utility is its adaptability, which includes selectable modes of operation and arrays of monitoring possibilities using more than one of the disclosed inventions. The user can set up several alert devices to monitor a single given variable, providing time dependent or situational awareness to the user via several cell phone alerts from different cell phone numbers. The user can likewise set up several devices to monitor a plurality of different physical variables, providing a higher level of monitoring and a greater range of situations. In this form, several devices monitor different situations, and the user can be made aware of the exact breach or violation being monitored by the corresponding phone number alert. Alternatively, a series of sensors may feed into an external controller that sends a signal to the alert device if even one sensor is tripped. Finally, in its simplest form, the device may be deployed singularly and independently to monitor one sensor and one variable.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A phone alert system for monitoring a third-party sensor and placing a call to a user, comprising:
a cellular phone;
a control circuit capable of accepting a signal from said third-party sensor and directing an outgoing call to a programmed phone number using said cellular phone;
a plurality of lead wires to a third party sensor;
a direct current power supply;
said control circuit manages said power to said cellular phone;
a digital display and a plurality of programming buttons for programming said control circuit.

2) A device as in claim 1, wherein said direct current power supply is a battery.

3) A device as in claim 1, wherein said signals comprise changes between two states in the form of either open or closed continuity (dry contacts), or in the form of either a disconnected state or a positive voltage (sourcing), or in the form of either a disconnected state or ground (sinking), or in the form of either a positive voltage or ground (sourcing and sinking).

4) A device as in claim 1, wherein said control circuit can be programmed to direct said cellular phone to send or not send an alert call to said user at a defined time of day.

5) A device as in claim 1, wherein said control circuit employs a counter to provide a means of making a cellular call as many times as said third party sensor is tripped even if said sensor is re-tripped before a preceding cellular call has been completed.

6) A device as in claim 1, wherein said cellular phone and control circuit are integrally mated with connections from a third party sensor and a power source.

7) A device as in claim 1, wherein an averaging period may be specified on said control circuit using said programming buttons and said digital display, reducing false alerts.

8) A device as in claim 1, wherein an inhibit period may be specified on said control circuit using said programming buttons and said digital display, reducing redundant alerts.

9) A phone alert system for monitoring a third-party sensor and placing a call to a user, comprising:
a cell phone transmitter;
a control circuit capable of accepting a signal from said third-party sensor and directing an outgoing call to a programmed phone number using said cellular phone;
a plurality of lead wires to a third party sensor;
a direct current power supply;
a control circuit for managing said power to said cellular phone;
a digital display and a plurality of programming buttons for programming said control circuit.

10) A device as in claim 9, wherein said direct current power supply is a battery.

11) A device as in claim 9, wherein said signal comprises a change between two states in the form of either open or closed continuity (dry contacts), or in the form of either a disconnected state or a positive voltage (sourcing), or in the form of either a disconnected state or ground (sinking), or in the form of either a positive voltage or ground (sourcing and sinking).

12) A device as in claim 9, wherein said control circuit can be programmed to direct said cellular phone to send or not send an alert call to said user at a defined time of day.

13) A device as in claim 9, wherein said control circuit employs a counter to provide a means of making a cellular call as many times as said third party sensor is tripped even if said sensor is re-tripped before a preceding cellular call has been completed.

14) A device as in claim 9, wherein said cellular phone and control circuit are integrally mated with connections for a third party sensor and a power source.

15) A method of monitoring a third-party sensor, comprising the steps of:
powering a control circuit to interpret and monitor a signal from said third party sensor;
directing a cellular phone device or embedded transmitter to alert a user in the event of a signal change from said third-party sensor;
powering said cellular device and control circuit with direct current power.

16) A method as describes in claim 15, further comprising the steps of:
programming said control circuit to direct said cellular device to alert a user at a given time of day to assure a user of system integrity.

17) A method as describes in claim 15, further comprising the steps of:
making a cellular call as many times as said third party sensor is tripped even if the sensor is re-tripped before a preceding cellular call has been completed.
